(19) United States
(12) Patent Application Publication
(10) Pub. No.: US 2002/0131914 A1
(43) Pub. Date: Sep. 19, 2002

(54) Catalyst composition

(75) Inventor: Shiang Sung, New York, NY (US)

Correspondence Address: Engelhard Corporation, 101 Wood Avenue, P.O. Box 770, Iselin, NJ, 08830-0770, US

(73) Assignee: Engelhard Corporation

(21) Appl. No.: 09/993,434

(22) Filed: Nov. 6, 2001

Related U.S. Application Data
(63) Continuation-in-part of application No. 09/294,601, filed on Apr. 19, 1999, now abandoned.

(51) Int. Cl. B01D 53/94; B01J 35/02; B01J 8/02; B01D 53/34; F01N 3/00

(52) U.S. Cl. 422/177; 502/304; 423/213.5; 422/168; 422/211

(57) ABSTRACT

Catalyst composition, apparatus and a method employing such composition for the treatment of engine exhaust gases to reduce pollutants contained therein. The catalyst composition is a three-way catalyst which may be used in a close-coupled or medium-coupled mode. Optionally, one or more downstream catalyst members may also be present. The catalyst composition comprises a mixture of (a) ceria having a weighted numerical average particle size of not greater than about 100 nm and (b) a catalytically effective amount of a platinum-group metal catalytic component such as palladium disposed on a refractory metal oxide support such as activated alumina. The catalyst composition contains substantially no organic compounds nor substantially any zirconia in the form of a composite or a solid solution with said ceria. The catalyst composition is preferably disposed on a carrier such as cordierite.

### CROSS-REFERENCE TO RELATED APPLICATION

This application is a continuation-in-part of co-pending application Ser. No. 09/294,601 filed Apr. 1, 1999, entitled “Catalyst Composition”.

### BACKGROUND OF THE INVENTION

1. Field of the Invention

The present invention relates to catalyst compositions and apparatus for, and a method for, the treatment of engine exhaust gases to reduce pollutants contained therein. More specifically, the present invention is concerned with catalyst compositions generally referred to as three-way conversion or “TWC” as well as to an apparatus and a method employing such catalyst compositions. The catalyst compositions may be used in the “close-coupled” or “medium-coupled” mode, preferably the close-coupled mode. Optionally, a downstream catalyst member may also be present.

2. Related Art

TWC catalyst compositions, known in the prior art, are polyfunctional in that they have the capability of substantially simultaneously catalyzing both oxidation and reduction reactions, such as the oxidation of hydrocarbons and carbon monoxide and the reduction of nitrogen oxides in a gaseous stream. Such catalyst compositions find utility in a number of fields, including the treatment of the exhaust gases from internal combustion engines, such as automobile, truck and other gasoline-fueled engines.

“Close-coupled” catalysts are known in the prior art and are generally defined as located in the engine compartment, typically less than one foot, more typically less than six inches from, and commonly attached directly to, the outlet of the exhaust manifold. “Medium-coupled” catalysts are also known in the prior art and are generally defined as located (downstream of any close-coupled catalyst) usually not more than about twenty-four, typically eighteen, inches from the outlet of the exhaust manifold Underfloor catalyst members are also known in the prior art and are located (downstream of any close-coupled and/or medium-coupled catalysts) under the floor of the vehicle adjacent to or in combination with the vehicle's muffler.

Motor vehicle exhaust treatment devices such as catalytic converters are, as stated above, known in the prior art and are conventionally located in underfloor position in the vehicle. For the purposes of the present invention, the term “vehicle” is to be understood as signifying a passenger car or truck and the term “engine” is to be understood as signifying a gasoline-powered internal combustion engine associated with the vehicle.

It is well known that by the time engine exhaust gases travel from the outlet of the exhaust manifold through an exhaust pipe to a catalytic converter, the gases cool significantly relative to the temperature at or near the manifold, so that there is a significant period of a low rate of conversion of the pollutants in the exhaust gas stream before the exhaust gases heat the catalyst in the catalytic converter to its light-off temperature. Accordingly, during the cold start period of engine operation, there is a significant discharge of engine exhaust gas containing a relatively high amount of pollutants.

It is also well known in the art to reduce the level of pollutants in the exhaust gas stream, particularly the level of hydrocarbons and carbon monoxide, by using an air pump in conjunction with the engine to help oxidize such pollutants. However, vehicle manufacturers would prefer to avoid using mechanical pollution control devices such as air pumps which, with their associated plumbing and mechanical parts, affect the engine architecture and are difficult to control without having an adverse impact on the optimum performance of the engine. Accordingly, vehicle manufacturers would prefer, if at all possible, to tune the engine for optimum performance without using mechanical types of a pollution control device and instead meet the vehicle emission standards discussed below solely with the use of catalyst members comprising one or more upstream catalyst bricks of the close-coupled and/or medium-coupled type and, if necessary, a catalytic converted located in an underfloor position. As discussed below, increasingly stringent governmental emission standards require, however, that cold-start emissions be reduced.

The current “LEV” (low emission vehicle) standards in effect for all states other than California prohibit vehicle emissions above 0.08 gram of non-methane hydrocarbons per mile, 3.4 grams of carbon monoxide per mile and 0.2 gram of NOₓ (nitrogen oxides) per mile. Many vehicle manufacturers have difficulty in meeting the current standards solely with the use of available upstream and/or downstream catalyst compositions without the concurrent use of additional mechanical devices such as air pumps. Of even greater concern is the fact that the California Air Resource Board (“CARB”) has promulgated new “ULEV” (ultra-low emission vehicle) standards that will prohibit vehicle emissions above 0.04 gram of non-methane hydrocarbons per mile, 1.7 grams of carbon monoxide per mile and 0.2 gram of NOₓ per mile. Moreover, based on historical trends in vehicle emission standards, it is likely that the new ULEV standards will be required nationwide within a few years. Unless an effective method of meeting the new ULEV standards can be rapidly developed and implemented, vehicle manufacturers face the difficult problem of achieving such standards without significant changes in engine/exhaust architecture, incorporation of additional mechanical pollution control devices and the use of large amounts of expensive precious metal-based catalyst systems.

For most vehicles, a large portion (i.e., up to about 80%) of the hydrocarbon emissions occurs during the first phase of the U.S. Federal Test Procedure (“FTP”), which encompasses the cold-start period of engine operation, and which requires simulation of cold-start warm-up, acceleration, cruise, deceleration and similar engine operating modes over a specified time period. A variety of technologies are under development to reduce cold start hydrocarbon emissions, including close-coupled catalysts as disclosed in Ball, D. J., “Distribution of warm-up and Underfloor Catalyst Volumes,” SAE 922338, 1992; electrically heated catalysts as disclosed in Piotrowski, G. K., “Evaluation of a Resistively Heated Metal Monolith Catalytic Converter on a Gasoline-Fueled Vehicle, EPA/AA/CTAAB/88-12,1988 and Hurley, R G., “Evaluation of Metallic and Electrically Heated Metallic Catalysts on a Gasoline Fueled Vehicle,” SAE 900504, 1990; hydrocarbon absorbers as disclosed in Heinrich, M J., Smith, L. R, and Kitowski, J., “Cold Start Hydrocarbon Collection for Advanced Exhaust Emission Control,” SAE 920847, 1992 and Hochmuth, J. K, Burk, P. L., Telentino, C., and Mignano, M. J., “Hydrocarbon Traps for Controlling Cold Start Emissions,” SAE 930739, 1993; bypass catalysts as disclosed in Fraidl, G. K., Quissrk, F. and Winklhofer, E., “Improvement of LEV/ULEV Potential of Fuel Efficient High Performance Engines,” SAE 920416, 1992; and burners as disclosed in Ma, T., Collings, N. and Hands, T., “Exhaust Gas Ignition (EGI)—A New Concept for Rapid Light-off of Automotive Exhaust Catalyst,” SAE 920400,1992. It has been reported that close-coupled catalysts, especially Pd-containing catalysts, are very effective at reducing hydrocarbon emissions during a cold start of the FTP cycle as disclosed in Ball, D. J., “Distribution of warm-up and Underfloor Catalyst Volumes,” SAE 922338, 1992; Summers, J. C., Skowron, J. F., and Miller, M. J., “Use of Light-Off Catalysts to Meet the California LEV/ULEV Standards,” SAE 930386, 1993 and Ball, D. J., “A Warm-up and Underfloor Converter Parametric Study,” SAE 932765, 1993. Recently, Ford has reported a successful application of Pd-only catalyst for meeting stringent emission standards as disclosed in Dettling, J., Hu, Z, Lui, Y., Smaling, R., Wan, C and Punke, A., “SMART Pd TWC Technology to Meet Stringent Standards,” Presented at CAPoC₃ Third International Congress on Catalyst and Automobile Pollution Control, Apr. 20-22, 1994, Brussels.

The principal function of a close-coupled catalyst, also referred to as “precat” and “warm-up” catalysts, is to reduce hydrocarbon emissions during a cold start. A cold start is the period immediately after starting the engine from ambient conditions. The cold start period depends on the ambient temperature, the type of engine, the engine control system and engine operation. Typically, the cold start period is within the first two minutes after the start of an engine at ambient temperature, FTP Test 1975 characterizes a cold start as the first bag of the FTP driving cycle which lasts for the first 505 seconds after starting an engine from ambient temperature, typically at 26C. This is accomplished by locating at least part of the total exhaust system catalyst closer to the engine than a traditional “underfloor catalyst.” The underfloor catalysts are typically located beneath the floor of the vehicle. The close-coupled catalyst is located in the engine compartment, i.e., beneath the hood and typically adjacent to the outlet of the exhaust manifold. There are several possible strategies for implementing a close-coupled catalyst. The close-coupled catalyst can occupy the entire catalyst volume or be a small volume catalyst used in conjunction with a medium-coupled catalyst and/or an underfloor catalyst. The design option depends on the engine configuration, size and space available. Catalysts at the close-coupled position are also exposed to high temperature exhaust gas immediately exiting the engine after the engine has warmed up. As a consequence, the close-coupled catalyst must have high temperature stability to be durable enough for meeting stringent emission standards as disclosed in Bhasin, M. et al, “Novel Catalyst for Treating Exhaust Gases from Internal Combustion and Stationary Source Engines,” SAE 93054, 1993. In the present day vehicle control strategies, overfueling or fuel enrichment is used to cool the engine exhaust prior to the catalyst during high load operation or high exhaust temperature conditions. This strategy results in increased hydrocarbon emissions and may be eliminated in future regulations as disclosed in “Acceleration Enrichment May Be a Large Source of Pollution,” WARD'S Engine and Vehicle Technology Update, Dec. 1, 1993, p.4. This could result in 50 to 100° C. higher exposure temperatures for the catalyst. Thus, the close-coupled catalyst could be exposed to temperatures as high as 1050° C. Additionally, high speed Autobahn driving conditions can expose the close-coupled catalyst to such high temperatures.

A typical motor vehicle catalyst is an underfloor three-way conversion catalyst (“TWC”) which catalyzes the oxidation by oxygen in the exhaust gas of the unburned hydrocarbons and carbon monoxide and the reduction of nitrogen oxides to nitrogen. TWC catalysts which exhibit good activity and long life comprise one or more platinum group metals (e.g., platinum or palladium, rhodium ruthenium and iridium) located upon a high surface area, refractory oxide support, e.g., a high surface area alumina coating. The support is carried on a suitable carrier or substrate such as a monolithic carrier comprising a refractory ceramic or metal honeycomb structure, or refractory particles such as spheres or short, extruded segments of a suitable refractory material.

U.S. Pat. No. 4,134,860 relates to the manufacture of catalyst structures. The catalyst composition can contain platinum group metals, base metals, rare earth metals and refractory, such as alumina support The composition can be deposited on a relatively inert carrier such as a honeycomb.

The high surface area alumina support materials, also referred to as “gamma alumina” or “activated alumina,” typically exhibit a BET surface area in excess of 60 square meters per gram (“m²/g”), often up to about 200 m²/g or more. Such activated alumina is usually a mixture of the gamma and delta phases of alumina, but may also contain substantial amounts of eta, kappa and theta alumina phases. It is disclosed to utilize refractory metal oxides other than activated alumina as a support for at least some of the catalytic components in a given catalyst For example, bulk ceria, zirconia, alpha alumina and other materials are known for such use. Although many of these materials suffer from the disadvantage of having a considerably lower BET surface area than activated alumina, that disadvantage tends to be offset by a great durability of the resulting catalyst.

In a moving vehicle, exhaust gas temperatures can reach 1000° C., and such elevated temperatures cause the activated alumina (or other) support material to undergo thermal degradation caused by a phase transition with accompanying volume shrinkage, especially in the presence of steam, whereby the catalytic metal becomes occluded in the shrunken support medium with a loss of exposed catalyst surface area and a corresponding decrease in catalytic activity. It is a known expedient in the art to stabilize alumina supports against such thermal degradation by the use of materials such as zirconia, titania, alkaline earth metal oxides such as baria, calcia or strontia or rare earth metal oxides, such as ceria, lanthana and mixtures of two or more rare earth metal oxides. For example, see C.D. Keith et al., U.S. Pat. No. 4,171,288.

Bulk cerium oxide (ceria) is disclosed to provide an excellent refractory oxide support for platinum group metals other than rhodium, and enables the attainment of highly dispersed, small crystallites of platinum on the ceria particles, and that the bulk ceria may be stabilized by impregnation with a solution of an aluminum compound, followed by calcination. U.S. Pat. No. 4,714,694 of C. Z. Wan et al., discloses aluminum-stabilized bulk ceria, optionally combined with an activated alumina, to serve as a refractory oxide support for platinum group metal components impregnated thereon The use of bulk ceria as a catalyst support for platinum group metal catalysts other than rhodium, is also disclosed in U.S. Pat. No. 4,727,052 of C. Z. Wan et al., and in U.S. Pat. No. 4,708,946 of Ohata et al.

U.S. Pat. No. 4,923,842 discloses a catalytic composition for treating exhaust gases comprising a first support having dispersed thereon at least one oxygen storage component and at least one noble metal component, and having dispersed immediately thereon an overlayer comprising lanthanum oxide and optionally a second support. The catalyst layer is separate from the lanthanum oxide. The noble metal can include platinum, palladium, rhodium, ruthenium and iridium. The oxygen storage component can include the oxide of a metal from the group consisting of iron, nickel, cobalt and the rare earths. Illustrative of these are cerium, lanthanum, neodymium, praseodymium, etc. Oxides of cerium and praseodymium are particularly useful as oxygen storage components.

U.S. Pat. No. 4,808,564 discloses a catalyst for the purification of exhaust gases having improved durability which comprises a support substrate, a catalyst carrier layer formed on the support substrate and catalyst ingredients carried on the catalyst carrier layer. The catalyst carrier layer comprises oxides of lanthanum and cerium in which the molar fraction of lanthanum atoms to total rare earth atoms is 0.05 to 0.20 and the ratio of the number of the total rare earth atoms to the number of aluminum atoms is 0.05 to 0.25.

U.S. Pat. No. 4,438,219 discloses an alumina-supported catalyst for use on a substrate. The catalyst is stable at high temperatures. The stabilizing material is disclosed to be one of several compounds including those derived from barium, silicon, rare earth metals, alkali and alkaline earth metals, boron, thorium, halfnium and zirconium. Of the stabilizing materials barium oxide, silicon dioxide and rare earth oxides which include lanthanum, cerium, praseodymium, neodymium, and others are indicated to be preferred. It is disclosed that contacting them with some calcined alumina film permits the calcined alumina film to retain a high surface area at higher temperatures.

U.S. Pat. Nos. 4,476,246,4,591,578 and 4,591,580 disclose three-way catalyst compositions comprising alumina, ceria, an alkali metal oxide promoter and noble metals. U.S. Pat. No. 4,591,518 discloses a catalyst comprising an alumina support with components deposited thereon consisting essentially of a lanthana component, ceria, an alkali metal oxide and a platinum group metal. U.S. Pat. No. 4,591,580 discloses an alumina-supported platinum group metal catalyst. The support is sequentially modified to include support stabilization by lanthana or lanthana rich rare earth oxides, double promotion by ceria and alkali metal oxides and optionally nickel oxide.

Palladium-containing catalyst compositions, see, e.g., U.S. Pat. No. 4,624,940, have been found useful for high temperature applications. The combination of lanthanum and barium is found to provide a superior hydrothermal stabilization of alumina which supports the catalytic component, palladium.

U.S. Pat. No. 4,780,447 discloses a catalyst which is capable of controlling HC, CO and NOₓ as well as H₂S in emissions from the tailpipe of catalytic converter-equipped automobiles. The use of the oxides of nickel and/or iron is disclosed as a hydrogen sulfide gettering-type of compound U.S. Pat. No. 4,965,243 discloses a method to improve thermal stability of a TWC catalyst containing precious metals by incorporating a barium compound and a zirconium compound together with ceria and alumina. This is stated to form a catalytic moiety to enhance stability of the alumina washcoat upon exposure to high temperature.

Patent J01210032 (and AU-615721) discloses a catalytic composition comprising palladium, rhodium, active alumina a cerium compound, a strontium compound and a zirconium compound. These patents suggest the utility of alkaline earth metals in combination with ceria, zirconias to form a thermally-stable alumina-supported palladium-containing washcoat.

U.S. Pat. Nos. 4,624,940 and 5,057,483 refer to ceria-zirconia containing particles. It is found that ceria can be dispersed homogeneously throughout the zirconia matrix up to 30 weight percent of the total weight of the ceria-zirconia composite to form a solid solution. A co-formed (e.g., co-precipitated) ceria oxide-zirconia particulate composite can enhance the ceria utility in particles containing ceria-zirconia mixture. The ceria provides the zirconia stabilization and also acts as an oxygen storage component. The '483 patent discloses that neodymium and/or yttrium can be added to the ceria-zirconia composite to modify the resultant oxide properties as desired.

U.S. Pat. No. 4,504,598 discloses a process for producing a high temperature resistant TWC catalyst. The process includes forming an aqueous slurry of particles of a gamma or activated alumina and impregnating the alumina with soluble salts of selected metals including cerium, zirconium, at least one of iron and nickel and at least one of platinum, palladium and rhodium and, optionally, at least one of neodymium, lanthanum, and praseodymium. The impregnated alumina is calcined at 600° C. and then dispersed in water to prepare a slurry which is coated on a honeycomb carrier and dried to obtain a finished catalyst.

U.S. Pat. No. 4,587,231 discloses a method of producing a monolithic three-way catalyst for the purification of exhaust gases. First, a mixed oxide coating is provided to a monolithic carrier by treating the carrier with a coating slip in which an active alumina powder containing cerium oxide is dispersed together with a ceria powder and then baking the treated carrier. Next platinum, rhodium and/or palladium are deposited on the oxide coating by thermal decomposition. Optionally, a zirconia powder may be added to the coating slip.

U.S. Pat. No. 5,064,803 discloses TWC catalysts containing ceria in the form of crystallites having a size less than 50 Å (5 μm) as measured by X-ray diffraction. However, the TWC is prepared by impregnating the support, e.g., gamma alumina with a solution of a cerium compound containing an organic compound, e.g., organic compounds containing at least two carbon atoms and comprising hydroxyl and/or carboxylic acid moieties capable of hydrogen bonding, such as polyols, sugars and organic acids. By contrast, the present invention is directed to a TWC-type catalyst composition comprising a mixture of:(a) ceria having a weighted numerical average particle size of not greater than about 100 nm and (b) a catalytically effective amount of a platinum-group metal catalytic component disposed on a refractory metal oxide support such as gamma alumina

U.S. Pat. No. 5,260,249 discloses TWC catalysts containing ceria having a particle size of not more than 250 Å (25 nm). However, the ceria is present in the form of a composite of, or as a solid solution with, zirconia By contrast, in the present invention, any zirconia which is present is utilized as a binder and is not present as a composite of, or as a solid solution with, zirconia.

It is a continuing goal to develop a close-coupled and/or medium-coupled TWC catalyst system which is inexpensive and stable and which permits the attainment of ULEV standards without the necessity for mechanical emission control devices such as air pumps and without adversely affecting the engine/exhaust architecture or performance.

### SUMMARY OF THE INVENTION

The present invention relates to a catalyst composition which may be utilized in a close-coupled and/or medium-coupled mode, in the form of a single or multiple bricks as well as to an apparatus and a related method of operation which utilize the catalyst composition of the invention for the reduction of pollutants in exhaust gases. Preferably, the catalyst composition of the invention is utilized in a close-coupled mode and is present in the form of a single brick or multiple bricks, depending on various factors such as the level of pollutants in the exhaust gas stream at the outset, desired maximum level of pollutants at the cold start phase of engine operation, auxiliary mechanical emission control devices such as air pumps, engine/exhaust architecture, etc. More particularly, the catalyst composition of the invention is designed to reduce pollutants in automotive engine exhaust gas streams at temperatures as low as 350° C., preferably as low as 300° C. and more preferably as low as 200° C. The catalyst composition of the present comprises components which catalyze low temperature reactions. This is indicated by the light-off temperature. The light-off temperature for a specific component is the temperature at which 50% of that component reacts.

The catalyst composition of the invention is preferably utilized in a close-coupled mode, i.e., it is placed close to the outlet of the exhaust manifold to enable it to reach reaction temperatures as soon as possible. However, during steady state operation of the engine, the proximity of the catalyst composition in a close-coupled mode to the engine exposes the catalyst composition to exhaust gases at very high temperatures of up to 1100° C. The catalyst is heated to a high temperature by heat from the hot exhaust gas and by heat generated by the combustion of hydrocarbons and carbon monoxide present in the exhaust gas. In addition to being very reactive at low temperatures, the catalyst composition should be stable at high temperatures during the operating life of the engine.

As indicated above, gasoline engines typically release exhaust gas pollutants which include hydrocarbons, carbon monoxide and nitrogen oxides. Typical catalytic converters are downstream catalytic units located “under the floor” of the automobile. Such catalytic converters comprise catalyst compositions which act as “three-way catalysts” (“TWC”). The TWC catalysts oxidize carbon monoxide and hydrocarbons and reduce nitrogen oxides. The carbon monoxide is oxidized to carbon dioxide and the hydrocarbons are oxidized to water and carbon dioxide. The nitrogen oxide is typically reduced to nitrogen gas.

The catalyst composition of the present invention when employed in a close-coupled and/or medium-coupled mode accomplishes the oxidation of hydrocarbons and carbon monoxide and the reduction of nitrogen oxides to a greater degree than prior art close-coupled and/or medium-coupled catalysts. Moreover, the catalyst composition of the invention is thermally stable upon exposure to temperatures up to 1100° C. and higher during the operating life of the engine. Such results have been accomplished due to the unique combination of components in the catalyst composition which provide thermal stability, particularly ceria, by its intrinsic nano-particle sized particles. At the same time, the catalyst composition of the invention provides a relatively high hydrocarbon conversion rate as well as a high rate of conversion of nitrogen oxides to nitrogen. Optionally, a catalytic member downstream of the catalyst composition of the invention employed in a close-coupled and/or medium-coupled mode, can be an underfloor catalytic converter.

### DETAILED DESCRIPTION OF THE INVENTION

The catalyst composition of the present invention is a TWC catalyst composition and comprises a mixture of (a) ceria having a weighted numerical average particle size of not greater than about 100 nm and (b) a catalytically effective amount of a platinum-group metal catalytic component disposed on a refractory metal oxide support. It has been found that by using ceria having a weighted numeral average particle size of not greater than about 100 nm, not only is the catalyst composition effective as a TWC catalyst for reducing emissions, especially “cold start” emissions, but it confers thermal stability required when the catalyst composition is utilized in the close-coupled mode, especially after steady state engine temperatures have been attained Further, the use of such particular type of ceria permits the attainment of LEV as well as ULEV standards without requiring excessive amounts of the platinum-group metal catalytic component and concurrently avoiding the necessity for altering the engine architecture and inclusion of mechanical types of emission control devices such as auxiliary air pumps.

Preferably, the catalyst composition of the invention is disposed on a carrier. In general, any suitable carrier may be used for the catalyst composition such as a monolithic carrier having a honeycomb structure, i.e., a plurality of gas flow passages extending therethrough from an inlet or an outlet face of the carrier, so that the passages are open to fluid flow therethrough. The passages are defined by walls on which the catalytic material is coated as a “washcoat” so that the gases flowing through the passages will contact the catalytic material. The flow passages of the monolithic carrier are thin-walled channels which can be of any suitable cross-sectional shape and size such as trapezoidal, rectangular, square, sinusoidal, hexagonal, oval, circular, etc. Such structures may contain from about 60 to about 700 or more, usually about 200 to 400, gas inlet openings(“cells”) per square inch of cross section.

The carrier may comprise a refractory ceramic or metal having a honeycomb structure. Suitable refractory ceramic materials include, for example, cordierite (which is preferred), cordierite-alpha alumina, silicon nitride, zircon mullite, spodumene, alumina-silica magnesia, zircon silicate, sillimanite, magnesium silicates, zircon petalite, alpha alumina and aluminosilicates. A metallic honeycomb made be made of a refractory metal such as stainless steel or other suitable iron-based corrosion-resistant alloys.

When coated onto such a carrier typically as a washcoat, the amounts of the various components are presented based on grams per volume. When the compositions are applied as a thin coating to a carrier substrate, the amounts of ingredients are conventionally expressed as grams per cubic foot (g/ft²) of carrier for platinum-group metal catalytic components and grams per cubic inch(g/in³) of a carrier for the other components as this measure accommodates different gas flow passage cell sizes in different monolithic carrier substrates.

Preferably, the ceria will have a weighted numerical average particle size of 1 to 30 nm and most preferably, 3 to 20 nm and typically will be present in an amount of about 0.01 to 1 g/in³ of carrier, preferably 0.04 to 0.5 g/in³ of carrier.

The platinum-group metal catalytic component may be a metal such as platinum, palladium or mixtures thereof, preferably palladium. In order to attain the desired oxidation of hydrocarbon and controlled oxidation of carbon monoxide, the amount of palladium is preferably greater than the sum of all of the other platinum-group metal catalytic components. Typically, the palladium will be present in an amount of about 20 to about 300 g/ft³ of a carrier, preferably 50 to 200 g/ft² of a carrier, together with from 0 to 20 g/ft² of a carrier of other platinum-group metal catalytic components selected from the group consisting of rhodium, ruthenium and iridium components and from 0 to 60 g/ft² of a carrier of a platinum metal catalytic component The platinum-group metal catalytic component is disposed on a refractory metal oxide support such as activated alumina (which is preferred), silica, titania, silica-alumina, alumina-silicates, aluminum-zirconium oxide, alumina-chromia, alumina-cerium oxide and mixtures thereof. Typically, the refractory metal oxide support will be present in the amount of about 0.1 to about 4.0 g/in³of carrier and will be present in the form of finely divided, high surface area particles having a particle size above 10-15 micrometers. Preferably, the activated alumina is thermally stabilized to retard undesirable alumina phase transformations from gamma to alpha at elevated temperatures by doping the activated alumina with a rare earth component such as lanthanum (preferred) or neodymium or mixtures thereof in an amount of about 0.02 to about 0.5 g/in³ of carrier. Preferably, the catalyst composition of the invention also contains a binder such as a zirconia in an amount of about 0.02 to about 1.5 g/in³ of carrier.

It is also preferred that the catalyst composition contain a promoter comprising an alkaline earth metal compound such as an oxide of magnesium, barium, calcium, strontium and mixtures thereof Typically, the promoter will be present in the amount of about 0.02 to about 0.5 g/in³ of carrier.

The catalyst composition of the invention may be employed in a close-coupled and/or medium-coupled mode and may be present in one or more appropriate containers, e.g., converters, containing the composition in the form of a single “brick” and/or multiple “bricks” which may abut one another or be spaced up to about 6 inches from one another. Optionally, one or more underfloor catalytic converters of the type discussed below may also be present downstream of the catalyst composition of the invention employed in a close-coupled and/or medium-coupled mode.

The downstream underfloor catalyst member comprises a catalytic material effective at least for the oxidation of hydrocarbons and comprising one or more downstream catalytic metal components dispersed on a second refractory metal oxide support and further comprising an oxygen storage component. The downstream catalyst member preferably comprises a three-way catalyst and an oxygen storage component such as ceria. The downstream catalytic material also preferably comprises rhodium and/or palladium in an amount sufficient to promote the reduction of NOₓ.

The catalyst composition of the invention, if employed in a close-coupled mode, serves to enhance pollutant conversion performance at a point that facilitates monitoring of catalytic performance for the purposes of California Air Resources Board (“CARB”) regulations concerning on-board diagnostics (i.e., “OBD II” regulations). In addition, the activity of such close-coupled catalyst member enhances the performance of the downstream underfloor catalyst member by raising the temperature of the exhaust gas, thus accelerating the rate at which the underfloor catalyst member attains its operating temperature.

Any suitable three-way catalytic materials known in the art may be used for the downstream catalyst member(s). Such catalytic materials typically comprise a platinum-group metal component comprising one or more metals such as platinum, palladium, rhodium, ruthenium, or iridium disposed on a second refractory metal oxide support such as activated alumina (which is preferred), silica, titania, silica-alumina, alumina-silicates, aluminum-zirconium oxide, alumina-chromia, alumina-cerium oxide and mixtures thereof Typically, the refractory metal oxide support will be present in an amount of about 0.1 to about 4.0 g/in. Preferably, the refractory metal oxide support is doped with a rare earth metal component such as lanthanum (which is preferred) or neodymium, which is believed to promote stability of the support. The metal oxide support may also contain a binder such as zirconia as well as one or more promoters preferably comprising at least one alkaline earth metal compound such as an oxide of magnesium, barium, calcium or strontium. If present, the binder, rare earth metal component and the promoter will each be utilized in an amount of about 0.02 to about 1.5 g/in³.

The downstream catalyst member preferably also includes an oxygen storage component, i.e., a multivalent, reducible, transition metal oxide of the type which is believed to be capable of tang up oxygen from an exhaust stream during relatively oxygen-rich periods and releasing oxygen into the stream during relatively oxygen-poor periods, thus reducing fluctuations in oxidation conversion performance. Suitable oxygen storage components comprise oxides of one or more of cerium (preferred), praseodymium, cobalt, iron, magnesium, molybdenum, nickel, tungsten or molybdenum. The oxygen storage component may be present in an amount of about 5 to about 20 weight percent of the downstream catalytic material and may be incorporated into particles of the support or other particulate components of the downstream catalytic material by methods known in the art, as described below.

The invention includes a method treating a gas comprising hydrocarbons, carbon monoxide and nitrogen oxides which comprises flowing the gas to a catalyst member comprising the catalyst composition of the invention described above and catalytically oxidizing the hydrocarbons and carbon monoxide and catalytically reducing the nitrogen oxides in the gas in the presence of the catalyst member. Typically, the gas will comprise an exhaust gas which emanates from a passenger vehicle or truck gasoline engine manifold. In such case, the catalyst member is present in a close-coupled mode (preferred) or medium-coupled mode.

The components of the catalyst composition employed for the method of the invention will be the same as those described above in respect to the catalyst composition and the apparatus of the invention. The optional feature of one or more downstream catalyst members, typically underfloor catalytic converters, as described above in respect to the apparatus of the invention, is also applicable to the method of the invention.

The catalyst composition of the invention, whether employed in a close-coupled and/or medium-coupled mode, may be prepared by methods well known in the art. Typically, the platinum-group metal catalytic component, e.g., palladium, is utilized in the form of a compound or complex to achieve dispersion of the component on the refractory metal oxide support, e.g., activated alumina. For the purposes of the present invention, the term “platinum-group metal catalytic component” means any compound, complex, or the like which, upon calcination or use thereof, decomposes or otherwise converts to a catalytically active form, usually the metal or the metal oxide. Water-soluble compounds or water-dispersible compounds or complexes of the metal component may be used as long as the liquid medium used to impregnate or deposit the metal component onto the refractory metal oxide support particles does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the platinum-group metals are preferred. For example, suitable compounds are chloroplatinic acid, amine-solubilized platinum hydroxide, palladium nitrate or palladium chloride, rhodium chloride, rhodium nitrate, hexamine rhodium chloride, etc. During the calcination step, or at least during the initial phase of use of the catalyst, such compounds are converted into a catalytically active form of the platinum-group metal or a compound thereof.

A preferred method of preparing the catalyst composition of the invention is to prepare a mixture of a solution of at least one platinum-group metal, e.g., palladium nitrates, and at least one finely divided, high surface area, refractory metal oxide support, e.g., activated alumina, which is sufficiently dryto absorb substantially all of the solution to form a slurry. Preferably, the slurry is acidic, having a pH of about 2 to less than 7. The pH of the slurry may be lowered by the addition of a minor amount of an inorganic or organic acid such as hydrochloric or nitric acid, preferably acetic acid, to the slurry. Thereafter, if desired, a refractory metal oxide support stabilizer, e.g., lanthanum nitrate, and/or a binder, e.g., zirconia acetate, and/or an alkaline earth metal compound promoter, e.g., strontium nitrate, may be added to the slurry.

In a particularly preferred embodiment, the slurry is thereafter comminuted to result in substantially all of the solids having particle sizes of less than 20 micrometers, i.e., 1-15 micrometers, in an average diameter. The comminution may be accomplished in a ball mill or other similar equipment, and the solids content of the slurry may be, e.g., 20-60 wt. %, preferably 3545 wt. %.

Subsequently, the ceria having the weighted numerical average particle size of not greater than about 100 nm, preferably 1-30 nm, most preferably, 3-20 nm, is added to, i.e., mixed with, the comminuted slurry of the platinum-group metal and the finely divided, high surface area, refractory metal oxide support. The resultant mixture in slurry form is then applied to the carrier in any desired manner. Thus the carrier may be dipped or sprayed with the complete slurry, until the appropriate amount of slurry is on the carrier. The slurry employed in depositing the catalytically-promoting metal component-high surface area support composite on the carrier will often contain about 20 to 60 weight percent of finely-divided solids, preferably about 35 to 45 weight percent. The coated carrier may then be dried and subsequently calcined at a temperature of 50° C. to 550° C. for 0.5 to 2.0 hours, thereby converting the various metal components to their insoluble form. The catalytic converter containing the catalyst composition of the invention may then be employed in a close-coupled and/or medium-coupled mode.

As mentioned above, the downstream catalyst member, typically present as one or more underfloor catalytic converters, will comprise a downstream catalytic material effective at least for the oxidation of hydrocarbons and comprise one or more downstream catalytic metal components, preferably a three-way catalyst, disposed on a refractory metal oxide support which may be the same as, or different from, the support employed in the upstream catalyst member, and further comprises an oxygen storage component. The downstream catalytic material also preferably comprises rhodium in an amount sufficient to promote the reduction of NOₓ. Typically, the downstream catalyst may contain the same components as are present in the catalyst composition of the invention which is preferably employed in the close-coupled and/or medium-coupled mode. Alternatively, the nano-particle sized ceria, i.e., the ceria having a weighted average numerical particle size of not greater than about 100 nm, may be partially or fully replaced by bulk ceria for the downstream catalyst composition and the method of preparation of the downstream catalytic material will therefore be quite similar to that used to prepare the upstream catalyst.

The downstream catalytic material will contain an oxygen storage component which may be in intimate contact with the platinum-group metal component, e.g., palladium. The oxygen storage component is any such material known in the art and preferably comprises at least one oxide of a metal selected from the group consisting of rare earth metals and most preferably cerium or praseodymium with the most preferred oxygen storage component being cerium oxide (ceria) which is preferably present in the bulk form rather than as nano-particle sized ceria. The oxygen storage component can be present in an amount of at least 5 wt. %, preferably at least 10 wt. %, and most preferably at least 15 wt. %, of the downstream catalyst composition The downstream catalyst member will preferably comprise a substrate, i.e., a carrier of the type recited above in respect to the upstream catalyst member, and either a single layer or two or more layers of the washcoat. If layered, the downstream catalyst composite comprises a first downstream layer catalyst composition and a second downstream layer catalyst composition. After passage through the upstream catalyst member, the exhaust gas stream initially encounters the second (i.e., the top or outer) downstream layer composition which is designed to effectively reduce nitrogen oxides to nitrogen and oxidize hydrocarbons while causing some oxidation of carbon monoxide. The exhaust gas then passes to the first downstream (i.e., the bottom or inner) layer to convert the rest of the pollutants, including the oxidation of hydrocarbons and remaining carbon monoxide.

The specific design of the first downstream layer results in effective oxidation of hydrocarbons over wide temperature ranges for long periods of time. In the preferred composite, the first downstream layer comprises a catalytically effective amount of a palladium component. Optionally, there can be minor amounts of platinum, 0 to 50, preferably 0 to 20 and most preferably 0 to 10 percent by weight of platinum metal based on the palladium component used in the first and second layers. Where platinum is used, typical minimum amounts are from about 1, preferably 3 and most preferably 5 percent by weight of platinum component based on platinum metal in the first and second layers.

The performance of the first layer palladium component can be enhanced by the use of the same type of binder, stabilizer and promoter recited above in respect to the upstream catalyst member. An oxygen storage component is preferably also included. The oxygen storage component can be in any form, including bulk form, part of a first oxygen storage composition, in or impregnated as a solution where there can be intimate contact between the oxygen storage component and the first layer platinum group metal components. The oxygen storage component enhances oxidation in the bottom layer. Intimate contact occurs when the oxygen storage component is introduced in the form of a solution of a soluble salt which impregnates the support and other particulate material and then can be converted to an oxide form upon calcining.

The second downstream layer comprises a second platinum component and/or a rhodium component. The second or top downstream layer contains from 50 to 100 weight percent of the platinum component based on the total platinum metal in the first and second layers. For the second downstream layer to result in higher temperature conversion efficiencies, an oxygen storage composition comprising a diluted oxygen storage component is used. A preferred oxygen storage composition is a composite comprising ceria and zirconia. This results in the second oxygen storage component having minimum intimate contact with the second platinum and rhodium components even where the second platinum and rhodium components are supported on the bulk oxygen storage composition particles. It is preferred to include a second zirconium component in the second layer.

The first downstream layer composition and second downstream layer composition respectively comprise a first support and a second support which can be the same or different support components. The support preferably comprises a high surface area refractory oxide support. Useful high surface area supports include one or more refractory oxides. These oxides include, for example, silica and alumina, include mixed oxide forms such as silica-alumina, aluminosilicates which may be amorphous or crystalline, alumina-zirconia, alumina-chromia, alumina-ceria and the like. The support substantially comprises alumina which preferably includes the members of the gamma or transitional alumina such as gamma and eta aluminas, and, if present, a minor amount of other refractory oxide, e.g., about up to 20 weight percent. Desirably, the active alumina has a specific surface area of 60 to 300 m²/g.

The preferred optional downstream catalyst comprises platinum-group metal components present in an amount sufficient to provide compositions having significantly enhanced catalytic activity to oxidize hydrocarbons and carbon monoxide and reduce nitrogen oxides. The location of the platinum group metal components, particularly the rhodium component and palladium component and the relative amounts of platinum components in the respective first and second layers have been found to affect the durability of catalyst activity. Additionally, the use of the dilute second oxygen storage component that does not intimately contact the majority of the platinum component and rhodium components also contributes to enhanced long term catalyst activity. In preparing the layered downstream catalyst, the same method as described above may be used to disperse or coat the palladium, platinum and rhodium components on the first and second refractory metal oxide support particles, e.g., activated alumina support particles.

The downstream catalyst can contain a first downstream oxygen storage component in the first layer which can be in bulk form or in intimate contact with the platinum group metal component, i.e., palladium. The oxygen storage component is any such material known in the art and preferably at least one oxide of a metal selected from the group consisting of rare earth metals, most preferably a cerium, praseodymium or a neodymium compound with the most preferred oxygen storage component being cerium oxide (ceria).

In the composition of the first downstream layer, the oxygen storage component can be included by dispersing methods known in the art. Such methods can include impregnation onto the first support composition. The oxygen storage component can be in the form of an aqueous solution. Drying and calcining the resultant mixture in air results in a first layer which contains an oxide of the oxygen storage component in intimate contact with the platinum metal component. Typically, impregnation means that there is substantially sufficient liquid to fill the pores of the material being impregnated. Examples of water soluble, decomposable oxygen storage components which can be used include, but are not limited to, cerium acetate, praseodymium acetate, cerium nitrate, praseodymium nitrate, etc. U.S. Pat. No. 4,189,404 discloses the impregnation of alumina-based support composition with cerium nitrate. If ceria is present in the first layer of the downstream catalyst composition, it may be, but is preferably not, present in the form of nano-particle sized ceria (i.e., having a particle size of not greater than about 100 nm), but preferably will be present in the form of particles having a larger particle size range, i.e., a particle size of 1 to 15 micrometers average diameter. In the second downstream layer, there is optionally and preferably a second oxygen storage composition which is preferably present in bulk form. The second oxygen storage composition comprises a second oxygen storage component which is preferably a cerium group component preferably ceria, praseodymia and/or neodymia, and most preferably ceria. By bulk form, it is meant that the composition comprising ceria and/or praseodymia are present as discrete particles which may be as small as 0.1 to 15 microns in diameter, as opposed to having been dispersed in solution as in the first layer. A description and the use of such bulk components are presented in U.S. Pat. No. 4,714,694, hereby incorporated by reference. As noted in U.S. Pat. No. 4,727,052, also incorporated by reference, bulk form includes oxygen storage composition particles of ceria admixed with particles of zirconia, or zirconia activated alumina It is particularly preferred to dilute the oxygen storage component as part of an oxygen storage component composition.

The oxygen storage component composition employed in the second downstream layer as well as the first downstream layer can comprise an oxygen storage component, preferably ceria and a diluent component. The diluent component can be any suitable filler which is inert to interaction with platinum group metal components so as not to adversely affect the catalytic activity of such components. A useful diluent material is a refractory oxide with preferred refractory oxides being of the same type of materials recited below for use as catalyst supports. Most preferred is a zirconium compound with zirconia most preferred. Therefore, a preferred oxygen storage component is a ceria-zirconia composite. There can be from 1 to 99, preferably 1 to 50, more preferably 5 to 30 and most preferably 10 to 25 weight percent ceria based on the ceria and zirconia. A preferred oxygen storage composition for use in the second layer composition, and optionally the first layer composition, can comprise a composite comprising zirconia, ceria and at least one rare earth oxide. Such materials are disclosed for example in U.S. Pat. Nos. 4,624,940 and 5,057,483, hereby incorporated by reference. Particularly preferred are particles comprising greater than 50% of a zirconia-based compound and preferably from 60 to 90% of zirconia, from 10 to 30 wt. % of ceria and optionally up to 10 wt. %, and when used at least 0.1 wt. %, of a non-ceria rare earth oxide useful to stabilize the zirconia selected from the group consisting of lanthana, neodymia and yttria. In the first downstream layer composition, the amount of thermal stabilizer(s) combined with the alumina may be from about 0.05 to 30 weight percent, preferably from about 0.1 to 25 weight percent, based on the total weight of the combined alumina, stabilizer (if any) and catalytic metal component.

Both the first downstream layer composition and the second downstream layer composition can contain a compound derived from zirconium, preferably zirconium oxide. The zirconium compound can be provided as a water soluble compound such as zirconium acetate or as a relatively insoluble compound such as zirconium hydroxide. There should be an amount sufficient to enhance the stabilization and promotion of the respective compositions.

The first downstream layer preferably contains lanthanum and neodymia and/or neodymium in the form of their oxides. Preferably, these compounds are initially provided in a soluble form such as an acetate, halide, nitrate, sulfate or the like to impregnate the solid components for conversion to oxides. It is preferred that in the first layer, the promoter be in intimate contact with the other components in the composition including and particularly the platinum group metal.

The first downstream layer composition and/or the second downstream layer composition of the present invention can also contain one or more of the promoters and the binder recited above in respect to the upstream catalyst.

The downstream catalyst composite can be coated in layers on the carrier of the type recited above in an amount of from about 0.50 to about 6.0, preferably about 1.0 to about 5.0 g/in³ of catalytic composition, based on grams of composition per volume of the carrier.

Each downstream layer of the present composite can also be prepared by the method in disclosed in U.S. Pat. No. 4,134,860 (incorporated by reference) generally recited as follows:

A finely-divided, high surface area, refractory oxide support is contacted with a solution of a water-soluble, catalytically-promoting metal component, preferably containing one or more platinum group metal components, to provide a mixture which is essentially devoid of free or unabsorbed liquid. The catalytically-promoting platinum group metal component of the solid, finely-divided mixture can be converted at this point in the process into an essentially water-insoluble form while the mixture remains essentially free of unabsorbed liquid. This process can be accomplished by employing a refractory oxide support, e.g., alumina, including stabilized aluminas, which is sufficiently dry to absorb essentially all of the solution containing the catalytically-promoting metal component, i.e., the amounts of the solution and the support, as well as the moisture content of the latter, are such that their mixture has an essential absence of free or unabsorbed solution when the addition of the catalytically-promoting metal component is complete. During the latter conversion or fixing of the catalytically-promoting metal component on the support, the composite remains essentially dry, i.e., it has substantially no separate or free liquid phase.

The mixture containing the fixed, catalytically-promoting metal component can be comminuted as a slurry which is preferably acidic, to provide solid particles that are advantageously primarily of a size of up to about 5 to 15 microns. The resulting slurry is preferably used to coat a macro size carrier, preferably having a low surface area, and the composite is dried and may be calcined In these catalysts the composite of the catalytically-promoting metal component and high area support exhibits strong adherence to the carrier, even when the latter is essentially non-porous as may be the case with, for example, metallic carriers, and the catalysts have very good catalytic activity and life when employed under strenuous reaction conditions. Each of the first and second layers can be repeatedly applied and calcined to form the composite of the present invention.

The method provides compositions of uniform and certain catalytically-promoting metal content since essentially all of the platinum group metal component thereby added to the preparation system remains in the catalyst, and the compositions contain essentially the calculated amount of the single or plural active catalytically-promoting metal components. In some instances a plurality of catalytically-active metal components may be deposited simultaneously or sequentially on a given refractory oxide support. The intimate mixing of separately prepared catalytically-promoting metal component refractory oxide composites of different composition made by the procedure of this invention, enables the manufacture of a variety of catalyst whose metal content may be closely controlled and selected for particular catalytic effects. Such mixed composites may, if desired, contain one or more catalytically-promoting metal components on a portion of the refractory oxide support particles, and one or more different catalytically-promoting metal components on another portion of the refractory oxide support particles. For example, the composite may have a platinum group metal component on a portion of the refractory oxide particles, and a base metal component on a different portion of the refractory oxide particles. Alternatively, different platinum group metals or different base metals may be deposited on separate portions of the refractory oxide support particles in a given composite. It is, therefore, apparent that this process is highly advantageous in that it provides catalysts which can be readily varied and closely controlled in composition.

The downstream layered catalyst composite can be used in the form of a self-supporting structure such as a pellet or on a suitable carrier or substrate, such as a metallic or ceramic honeycomb. The first downstream layer composition and second downstream layer composition of the present invention can be prepared and formed into pellets by known means or applied to a suitable substrate, preferably a metal or ceramic honeycomb carrier. The comminuted catalytically-promoting metal component-high surface area support composite can be deposited on the carrier in a desired amount, for example, the composite may comprise about 2 to 30 weight percent of the coated carrier, and is preferably about 5 to 20 weight percent. The composite deposited on the carrier is generally formed as a coating over most, if not all, of the surfaces of the carrier contacted The combined structure may be dried and calcined, preferably at a temperature above about 250° C., but not so high as to unduly destroy the high area of the refractory oxide support, unless such is desired in a given situation. Preferably, the composition of the smaller upstream zone is designed to have a lower light-off temperature than the downstream zone. Thereby, the upstream zone heats up and catalyzes the reaction sooner. It is also designed to operate during conditions, such as during idle, when residence time may be longer, and space velocities may be lower than during steady state operation. For the purpose of the present invention, the term “light-off” means the temperature at which the catalyst becomes active and can initiate the reaction of the exhaust gas components. Stated another way, the residence time is indicated by the reciprocal of the space velocity For the purpose of the present invention, the term “space velocity” means the volume of gas that passes through the catalytic member in a given time period divided by the total volume of the catalytic member and is measured in reciprocal time units such as reciprocal hours. The apparatus of the present invention can advantageously be used at space velocities ranging from 10 to 500,000 and more typically from 50 to 350,000 reciprocal hours.

The catalyst compositions of the present invention can be employed to promote chemical reactions, such as reductions, methanations and especially the oxidation of carbonaceous materials, e.g., carbon monoxide, hydrocarbons, oxygen-containing organic compounds, and the like, to products having a higher weight percentage of oxygen per molecule such as intermediate oxidation products, carbon dioxide and water, the latter two materials being relatively innocuous materials from an air pollution standpoint. Advantageously, the catalytic compositions can be used to provide removal from gaseous exhaust effluents of uncombusted or partially combusted carbonaceous fuel components such as carbon monoxide, hydrocarbons, and intermediate oxidation products composed primarily of carbon, hydrogen and oxygen, or nitrogen oxides. Although some oxidation or reduction reactions may occur at relatively low temperatures, they are often conducted at elevated temperatures of, for instance, at least about 150° C., preferably about 200 to 900° C., and generally with the feedstock in the vapor phase. The materials which are subject to oxidation generally contain carbon, and may, therefore, be termed carbonaceous, whether they are organic or inorganic in nature. The catalysts are thus useful in promoting the oxidation of hydrocarbons, oxygen-containing organic components, and carbon monoxide, and the reduction of nitrogen oxides. These types of materials may be present in exhaust gases from the combustion of carbonaceous fuels, and the catalysts are useful in promoting the oxidation or reduction of materials in such effluents. The exhaust from internal combustion engines operating on hydrocarbon fuels, as well as other waste gases, can be oxidized by contact with the catalyst and molecular oxygen which may be present in the gas stream as part of the effluent, or may be added as air or other desired form having a greater or lesser oxygen concentration The products from the oxidation contain a greater weight ratio of oxygen to carbon than in the feed material subjected to oxidation An advantage of the apparatus of the present invention is that the downstream catalyst member can be used in the “underfloor” position of motor vehicles. Many such reaction systems are known in the art.

The present invention is illustrated further by the following examples which are not intended to limit the scope of this invention.

### EXAMPLE 1

A carrier consisting of a cordierite monolith having a cell density of 400 cells/in² was coated with a slurry containing palladium-coated alumina (the palladium loading was 150 g/ft³ of the carrier), strontium nitrate, neodymium nitrate, zirconium acetate, lanthanum nitrate, ceria having a weighted numerical average particle size of 9 nm, acetic acid and water. The coated monolith was dried in an oven at 100° C. for six hours and was then calcined at 550° C. for one hour. The monolith carrier, in the form of a brick, had a length of 2.5 inches and a diameter of 3.66 inches. The resultant catalyst had the following composition:

| Component | Wt. % |
|---|---|
| Alumina | 64.2 |
| PdOx | 4.5 |
| SrOx | 5.2 |
| NdOx | 8.4 |
| ZrOx | 5.2 |
| LaOx | 9.9 |
| CeOx | 2.6 |
| | 100.0 |

### EXAMPLE 2

Example 1 was repeated using the same slurry, except that the palladium loading was 200 g/ft³ and the ceria was omitted. The monolith carrier, in the form of a brick, had a length of 2.5 inches and a diameter of 3.66 inches. The catalyst had the following composition:

| Component | Wt. % |
|---|---|
| Alumina | 64.9 |
| PdOx | 6.1 |
| SrOx | 5.3 |
| NdOx | 8.4 |
| ZrOx | 5.3 |
| LaOx | 10.0 |
| | 100.0 |

A catalytic converter containing two catalyst bricks was aged under lean-rich peturbation conditions for 100 hours at an inlet temperature of the converter of 820° C. A vehicle evaluation under Federal Testing Procedure (“FTP”) 75 was carried out using a 1999 model year 5.7L Blazer containing an air pump with a catalytic converter located approximately 18 inches from the outlet of the engine exhaust manifold. Each converter contained two catalyst bricks: a front catalyst brick consisting of the catalyst of either Example 1 or Example 2 and a rear catalyst brick having a length of 4.5 inches and a diameter of 3.66 inches abutting, and located downstream of the front brick and consisting of a common Pd/Rh (Pd:Rh=8:1) catalyst at a catalyst loading of 80 g/ft³ was used during the aging and evaluation. The results are set forth in Table I:

TABLE I

| | | Engine Out, | | | Tailpipe | | | | | |
|---|---|---|---|---|---|---|---|---|---|---|
| | | g/mile | | | Emission, g/mile | | | Conversion, % | | |
| Catalyst | Pd, g/ft³ | HC | CO | NOₓ | HC | CO | NOₓ | HC | CO | NOₓ |
| Example 1 | 150 | 2.4 | 17.4 | 2.9 | 0.073 | 1.52 | 0.20 | 97.0 | 91.2 | 93.3 |
| Example 2 | 200 | 2.4 | 17.6 | 3.3 | 0.099 | 1.80 | 0.18 | 95.9 | 89.8 | 94.5 |

As may be seen from the results set forth in Table I, the catalyst of Example 1 containing the nano-particle sized ceria provided superior results in respect to conversion percentage of hydrocarbons and carbon monoxide. Such result was quite surprising since the expensive precious metal component in the catalyst of Example 1, i.e., the palladium, was present at a lower loading level than that of Example 2 (150 g/ft³ versus 200 g/ft³). This is of significant interest to vehicle manufacturers who are concerned about meeting LEV and ULEV standards without using increased amounts of precious metal components.

### EXAMPLE 4

A carrier consisting of a cordierite monolith having a cell density of 400 cells/in² was coated with a slurry containing palladium-coated alumina (the palladium loading was 150 g/ft³ of the carrier), strontium nitrate, neodymium nitrate, zirconium acetate, lanthanum nitrate, bulk ceria, ceria having a weighted numerical average particle size of 9 nm, acetic acid and water. The coated monolith having a length of 3 inches and a diameter of 3.66 inches was dried in an oven at 100° C. for six hours and was then calcined at 550° C. for one hour. The resultant catalyst had the following composition:

| Component | Wt. % |
|---|---|
| Alumina | 59.5 |
| PdOx | 4.2 |
| SrOx | 4.8 |
| NdOx | 7.7 |
| ZrOx | 4.8 |
| LaOx | 9.2 |
| CeOx, 9nm | 4.8 |
| CeOx, bulk | 4.8 |
| | 100.0 |

### EXAMPLE 5

A carrier (3 inches length, 3.66 inches diameter) consisting of a cordierite monolith having a cell density of 400 cells/in³ was coated with a slurry containing palladium-coated alumina (the palladium loading was 150 g/ft³ of the carrier), strontium nitrate, neodymium nitrate, zirconium acetate, lanthanum nitrate, a bulk ceria-zirconia composite, acetic acid and water. The coated monolith was dried in an oven at 1000° C. for six hours and was then calcined at 550° C. for one hour. The resultant catalyst had the following composition:

| Component | Wt. % |
|---|---|
| Alumina | 52.0 |
| PdOx | 3.7 |
| SrOx | 4.2 |
| NdOx | 6.8 |
| ZrOx | 4.2 |
| LaOx | 8.0 |
| (Ce-Zr) Ox | 21.1 |
| | 100.0 |

### EXAMPLE 6

A system consisting of two catalytic converters was aged under lean-rich peturbation conditions at an inlet temperature of the close-coupled converter at 850C. for 100 hours. The close-coupled converter was installed abutting the outlet of the engine exhaust manifold, while the second converter was an under-the-floor converter installed 45 inches downstream of the outlet of the engine exhaust manifold. A vehicle evaluation under FTP75 was conducted using a 1999 model year 1.9L Saturn, without any air pump being present. The close-coupled converter contained each of the catalyst bricks of Examples 4 and 5, while the under-the-floor converter contained a catalyst brick having a dimension of 6 inches length, a width of 3.15 inches and a depth of 4.75 inches (oval) consisting of a common Pd/Rh (Pd:Rh=8:1) catalyst at a loading of 80 g/ft³. The results are set forth in Table II:

TABLE II

| | | Engine Out, | | | Tailpipe | | | | | |
|---|---|---|---|---|---|---|---|---|---|---|
| | Pd, | g/mile | | | Emission, g/mile | | | Conversion, % | | |
| Catalyst | g/ft³ | HC | CO | NOₓ | HC | CO | NOₓ | HC | CO | NOₓ |
| Example 4 | 150 | 1.35 | 7.23 | 2.18 | 0.046 | 0.511 | 0.057 | 96.6 | 92.9 | 97.4 |
| Example 5 | 150 | 1.38 | 9.12 | 2.29 | 0.0565 | 0.775 | 0.055 | 95.9 | 91.5 | 97.6 |

The results in Table II clearly indicate the advantages of using a nano-particle sized ceria in the catalyst composition Even though no air pump was present, and the precious metal loading for both catalysts was the same, the conversion percentage for both HC and CO was higher for the catalyst of Example 4 containing the nano-particle sized ceria as compared to that of Example 5 which contained a bulk ceria-zirconia composite, while the conversion rate for NOₓ was substantially the same.

### EXAMPLE 7

In this example, a comparison was made between the catalysts of Examples 1 and 5 and that of Example 2 which was reformulated so as to contain a palladium loading of 150 g/ft³ rather than 200 g/ft³. Thus all three catalysts contained a palladium loading of 150 g/ft³. The three catalysts were then evaluated in the Light-off test using an engine dynamometer at the following conditions: space velocity: 60,000 hr⁻¹; lambda: 1.01; peturbation: 1.8 Hz. All three catalysts were conditioned for 0.5 hour at 700° C., under stoichiometric conditions (lambda=1.0) prior to conducting the Light-Off test. The results set forth in Table III clearly indicate the advantages of using a catalyst composition containing nano-particle sized ceria (Example 1) over a catalyst composition containing no ceria (Example 2) and a catalyst composition containing bulk ceria-zirconia composite.

TABLE III

| Catalyst | Light-Off, ° C.-HC | Light-Off, ° C.-CO |
|---|---|---|
| Example 1 | 257 | 257 |
| Example 2 | 270 | 271 |
| Example 5 | 285 | 295 |

### EXAMPLE 8

This example describes the preparation of a catalyst in accordance with the teachings in U.S. Pat. No. 5,064,843, issued Nov. 12, 1991 to Nunan.

103.3 g of Ce(NO₃)₃.6 H₂O and 91.4 g of citric acid were dissolved in 300 g of methanol in a 1-liter round bottom flask. 100 g of gamma alumina were added to the mixture while stirring. The methanol was evaporated off under vacuum in a water bath set at 50° C. The powder was then dried at 150° C. for 24 hours and thereafter calcined at 600° C.; calcination was accomplished by slowly raising the temperature to 600° C. and maintaining such temperature for 6 hours. X-ray diffraction analysis of the resultant powder showed that the crystallite size of the ceria was 34 Å, very close to the size of 27 Å described in the Nunan patent.

The resultant powder was ball milled with water to form a slurry. It was then dried to form a cake, calcined and crushed to 2040 mesh. The material was then impregnated with platinum and rhodium solutions. The total loadings were 0.81% at a platinum:rhodium ratio of 19:1. The impregnated catalyst was coated onto a cordierite carrier having a diameter of 1.5 inches, a length of 3 inches and a cell density of 400 cells/in². The coated cordierite was then subjected to final calcination in air at 600° C. for 6 hours. Cores samples of the resultant coated cordierite were taken and aged in an engine dynamometer under rich-lean peturbations at an inlet gas temperature of 850° C. for 50 hours. The core samples were evaluated by the Sweep Test and the Light-Off Test described below.

### EXAMPLE 9

187.5 g of gamma alumina and 63.13 g of the nano-particle ceria of the present invention were mixed in a planetary mixer. After calcination at 600° C. for 6 hours, the mixed powder was subjected to X-ray diffraction analysis; such analysis indicated that the crystallite size of the ceria was 75 Å.

The mixed powder was then impregnated with platinum and rhodium solutions. The total loadings were 0.81% at a platinum: rhodium ratio of 19:1. Water was then added to the resultant impregnated powder to form a slurry having a solids content of 40%. The slurry was then ball milled to the point that 90% of the particles had a particle size of less than 10 microns. The impregnated catalyst was coated onto a cordierite carrier having a diameter of 1.5 inches, a length of 3 inches and a cell density of 400 cells/in². The coated cordierite was then subjected to final calcination in air at 600° C. for 6 hours. Cores samples of the resultant coated cordierite were taken and aged in an engine dynamometer under rich-lean peturbations at an inlet gas temperature of 850° C. for 50 hours. The core samples were evaluated by the Sweep Test and the Light-Off Test described below.

### Sweep Test

The aged catalyst core samples of Examples 8 and 9 were subjected to Sweep Tests using the engine dynamometer at 500° C. at air/fuel ratios varying lambda from 0.97 to 1.03 The peturbation frequency was 1 Hz. The space velocity was 100,000. The results of the Sweep Test which measures catalyst performance under acceleration and deceleration modes are set forth in Tables IV and V below.

TABLE IV
% HC Conversion

| A/F Ratio. λ | 0.97 | 0.98 | 0.99 | 1 | 1.01 | 1.02 | 1.03 |
|---|---|---|---|---|---|---|---|
| Ex. 8 (Nunan) | 25 | 41 | 74 | 89 | 91 | 90 | 89 |
| Ex. 9 (Invention) | 41 | 65 | 89 | 92 | 92 | 89 | 90 |

TABLE V
% NOₓ Conversion

| A/F Ratio. λ | 0.97 | 0.98 | 0.99 | 1 | 1.01 | 1.02 | 1.03 |
|---|---|---|---|---|---|---|---|
| Ex. 8 (Nunan) | 20 | 36 | 67 | 61 | 33 | 11 | 8 |
| Ex. 9 (Invention) | 38 | 63 | 81 | 67 | 34 | 10 | 4 |

As may be seen from the data in Tables IV and V, the catalyst of the present invention Example 9) performed significantly better in respect to both % HC conversion as well as % NOₓ conversion as compared to Nunan (Example 8), even though the precious metal loadings of both catalysts were identical.

### Light-Off Test

The aged catalyst core samples of Examples 8 and 9 were subjected to Light-Off Tests using a laboratory reactor equipped with a model gas (to simulate the typical exhaust gas composition as closely as possible without compromising experimental control and screening ability). The temperature ramp rate 10° C./minute and the space velocity was 60,000. The results of the Light-Off Tests are shown in Tables VI-IX below.

TABLE VI
% HC Conversion

| Temperature, ° C. | 200 | 250 | 300 | 350 | 400 | 450 | 500 |
|---|---|---|---|---|---|---|---|
| Ex. 8 (Nunan) | 0 | 0 | 0 | 5 | 67 | 75 | 80 |
| Ex. 9 (Invention) | 0 | 0 | 0 | 38 | 74 | 80 | 84 |

TABLE VII
% CO Conversion

| Temperature, ° C. | 200 | 250 | 300 | 350 | 400 | 450 | 500 |
|---|---|---|---|---|---|---|---|
| Ex. 8 (Nunan) | 0 | 1 | 3 | 26 | 63 | 64 | 64 |
| Ex. 9 (Invention) | 0 | 1 | 4 | 52 | 71 | 68 | 66 |

TABLE VIII
% NOₓ Conversion

| Temperature, ° C. | 200 | 250 | 300 | 350 | 400 | 450 | 500 |
|---|---|---|---|---|---|---|---|
| Ex. 8 (Nunan) | 0 | 0 | 3 | 25 | 57 | 49 | 44 |
| Ex. 9 (Invention) | 0 | 0 | 6 | 54 | 61 | 55 | 52 |

TABLE IX
Light-Off Temperature, ° C., at 50% Conversion

| Example | HC | CO | NOₓ |
|---|---|---|---|
| 8 (Nunan) | 382 | 378 | 379 |
| 9 (Invention) | 356 | 349 | 347 |

As may be seen from the results in Tables VI-VII, the catalyst of the present invention (Example 9) performed significantly better than the Nunan catalyst (Example 8) in respect to % HC conversion, % CO conversion and % NOₓ conversion at every temperature, even though the precious metal loadings of both catalysts were identical. The results in Table IX shows that the 50% conversion level of HC, CO and NOₓ, the catalyst of the present invention (Example 9) consistently exhibited lower light-off temperatures as compared to the Nunan catalyst (Example 8), even though the precious metal loadings of both catalysts were identical.

What is claimed is:

1. A catalyst composition comprising a mixture of: (a) ceria having a weighted numerical average particle size of not greater than about 100 μm and (b) a catalytically effective amount of a platinum-group metal catalytic component disposed on a refractory metal oxide support, said catalyst composition containing substantially no organic compounds nor substantially any zirconia in the form of a composite or a solid solution with said ceria.

2. The catalyst composition of claim 1 which is disposed on a carrier.

3. The catalyst composition of claim 2 wherein the carrier is a monolithic carrier comprising a refractory ceramic or metal having a honeycomb structure.

4. The catalyst composition of claim 3 wherein the carrier comprises cordierite.

5. The catalyst composition of claim 1 wherein the ceria has a weighted numerical average particle size of about 1 to about 30 nm.

6. The catalyst composition of claim 5 wherein the ceria has a weighted numerical average particle size of 3 to 20 nm.

7. The catalyst composition of claim 2 wherein the ceria is present in an amount of about 0.01 to about 1 g/in³of the carrier.

8. The catalyst composition of claim 7 wherein the ceria is present in an amount of 0.04 to 0.5 g/in³ of the carrier.

9. The catalyst composition of claim 2 wherein the platinum-group metal catalytic component comprises a palladium metal catalytic component.

10. The catalyst composition of claim 9 wherein the palladium metal catalytic component is present in an amount of about 20 to about 300 g/ft³ of the carrier.

11. The catalyst composition of claim 10 wherein the palladium metal catalytic component is present in an amount of 50 to 200 g/ft² of the carrier.

12. The catalyst composition of claim 2 wherein the refractory metal oxide support is selected from the group consisting of activated alumina, silica, titania, silica-alumina, alumina-silicates, aluminum-zirconium oxide, alumina-chromia, alumina-cerium oxide and mixtures thereof.

13. The catalyst composition of claim 12 wherein the refractory metal oxide support comprises activated alumina.

14. The catalyst composition of claim 13 wherein the activated alumina is present in an amount of about 0.1 to about 4.0 g/in³ of the carrier.

15. The catalyst composition of claim 13 wherein the activated alumina is stabilized with a lanthanum component.

16. The catalyst composition of claim 15 wherein the lanthanum component is present in an amount of about 0.02 to about 0.5 g/in³ of the carrier.

17. The catalyst composition of claim 2 further including a binder comprising zirconia.

18. The catalyst composition of claim 17 wherein the zirconia is present in an amount of about 0.02 to about 1.5 g/in³ of the carrier.

19. The catalyst composition of claim 2 further including a promoter comprising an alkaline earth metal compound.

20. The catalyst composition of claim 19 wherein the alkaline earth metal compound is selected from the group consisting of oxides of magnesium, barium, calcium, strontium and mixtures thereof.

21. The catalyst composition of claim 20 wherein the alkaline earth metal compound is present in an amount of about 0.02 to about 0.5 g/in³ of the carrier.

22. An apparatus for abating pollutants contained in the exhaust of an engine comprising a catalyst member comprising a catalytic composition effective for simultaneously substantially catalyzing the oxidation of hydrocarbons and carbon monoxide and the reduction of nitrogen oxides, said catalytic composition comprising a mixture of (a) ceria having a weighted numerical average particle size of not greater than about 100 nm and (b) a catalytically effective amount of a platinum-group metal catalytic component disposed on a first refractory metal oxide support, said catalyst composition containing substantially no organic compounds nor substantially any zirconia in the form of a composite or a solid solution with said carrier.

23. The apparatus of claim 22 wherein the catalytic composition is disposed on a carrier.

24. The apparatus of claim 23 wherein the carrier is a monolithic carrier comprising a refractory ceramic or metal having a honeycomb structure.

25. The apparatus of claim 24 wherein the carrier comprises cordierite.

26. The apparatus of claim 22 wherein the ceria has a weighted numerical average particle size of about 1 to about 30 nm.

27. The apparatus of claim 26 wherein the ceria has a weighted numerical average particle size of 3 to 20 nm.

28. The apparatus of claim 23 wherein the ceria is present in an amount of about 0.01 to about 1 g/n³ of the carrier.

29. The apparatus of claim 28 wherein the ceria is present in an amount of 0.04 to 0.5 g/in³ of the carrier.

30. The apparatus of claim 23 wherein the refractory metal oxide support is selected from the group consisting of activated alumina, silica, titania, silica-alumina, alumina-silicates, aluminum-zirconium oxide, alumina-chromia, alumina-cerium oxide and mixtures thereof.

31. The apparatus of claim 30 wherein the refractory metal oxide comprises activated alumina.

32. The apparatus of claim 31 wherein the activated alumina is present in an amount of about 0.1 to about 4.0 g/in³ of the carrier.

33. The apparatus of claim 31 wherein the activated alumina is stabilized with a lanthanum component.

34. The apparatus of claim 33 wherein the lanthanum component is present in an amount of about 0.02 to about 0.5 g/in³ of the carrier.

35. The apparatus of claim 23 wherein the catalyst composition further includes a binder comprising zirconia.

36. The apparatus of claim 35 wherein the zirconia is present in an amount of about 0.02 to about 1.5 g/in³ of the carrier.

37. The apparatus of claim 23 wherein the catalytic composition includes a promoter comprising an alkaline earth metal compound.

38. The apparatus of claim 37 wherein the alkaline earth metal compound is selected from the group consisting of oxides of magnesium, barium, calcium, strontium and mixtures thereof.

39. The apparatus of claim 38 wherein the alkaline earth metal compound is present in an amount of about 0.02 to about 0.5 g/in³ of the carrier.

40. The apparatus of claim 23 wherein the exhaust emanates from a passenger vehicle or thick gasoline engine manifold, the catalyst member is present in a close-coupled or medium-coupled mode and the platinum-group metal catalytic component comprises a palladium metal catalytic component.

41. The apparatus of claim 40 wherein the catalyst member is present in a close-coupled mode and the palladium metal catalytic component is present in an amount of about 20 to about 300 g/ft³ of the carrier.

42. The apparatus of claim 41 wherein the palladium metal catalytic component is present in an amount of 50 to 200 g/ft³ of the carrier.

43. The apparatus of claim 40 wherein the catalyst member comprises one or more upstream containers present in a close-coupled and/or medium-coupled mode and the catalyst composition is present in said containers in the form of a single brick, multiple bricks or pellets.

44. The apparatus of claim 43 further comprising one or more downstream containers located downstream of the upstream containers, said downstream containers containing a catalytic material effective at least for the oxidation of hydrocarbons and comprising one or more catalytic metal components disposed on a refractory metal oxide support and further comprising an oxygen storage component.

45. The apparatus of claim 44 wherein the catalytic material is present in the downstream containers in the form of a single brick, multiple bricks or pellets.

46. The apparatus of claim 44 wherein the catalytic metal component comprises rhodium.

47. The apparatus of claim 44 wherein the catalytic metal component comprises palladium.

48. The apparatus of claim 44 wherein the oxygen storage component comprises ceria.

49. The apparatus of claim 22 further comprising an underfloor catalyst member comprising a catalytic material effective at least for the oxidation of hydrocarbons and comprising one or more catalytic metal components disposed on a second refractory metal oxide support and further comprising an oxygen storage component.7

50. The apparatus of claim 49 wherein the catalytic metal component comprises rhodium.

51. The apparatus of claim 49 wherein the catalytic metal component comprises palladium.

52. The apparatus of claim 49 wherein the oxygen storage component comprises ceria.

53. A method for treating a gas comprising hydrocarbons, carbon monoxide and nitrogen oxides which comprises flowing the gas to a catalyst member comprising a catalyst composition comprising a mixture of (a) ceria having a weighted numerical average particle size of not greater than about 100 nm and (b) a catalytically effective amount of a platinum-group metal catalytic component disposed on a refractory metal oxide support and catalytically oxidizing the hydrocarbons and carbon monoxide and catalytically reducing the nitrogen oxides in the gas in the presence of the catalyst member, said catalyst composition containing substantially no organic compounds nor substantially any zirconia in the form of a composite or a solid solution with said ceria.

54. The method of claim 53 wherein the catalyst composition is disposed on a carrier.

55. The method of claim 54 wherein the carrier is a monolithic carrier comprising a refractory ceramic or metal having a honeycomb structure.

56. The method of claim 55 wherein the carrier comprises cordierite.

57. The method of claim 53 wherein the ceria has a weighted numerical average particle size of about 1 to about 30 nm.

58. The method of claim 57 wherein the ceria has a weighted numerical average particle size of 3 to 20 nm.

59. The method of claim 54 wherein the ceria is present in an amount of about 0.01 to about 1 g/in³of the carrier.

60. The method of claim 59 wherein the ceria is present in an amount of 0.04 to 0.5 g/in³ of the carrier.

61. The method of claim 54 wherein the refractory metal oxide support is selected from the group consisting of activated alumina, silica, titania, silica-alumina, alumina-silicates, aluminum-zirconium oxide, alumina-chromia, alumina-cerium oxide and mixtures thereof.

62. The method of claim 61 wherein the refractory metal oxide comprises activated alumina.

63. The method of claim 62 wherein the activated alumina is present in an amount of about 0.1 to about 4.0 g/in³ of the carrier.

64. The method of claim 63 wherein the activated alumina is stabilized with a lanthanum component.

65. The method of claim 64 wherein the lanthanum component is present in an amount of about 0.02 to about 0.5 g/in³ of the carrier.

66. The method of claim 54 wherein the catalytic composition further includes a binder comprising zirconia.

67. The method of claim 66 wherein the zirconia is present in an amount of about 0.02 to about 1.5 g/in³ of the carrier.

68. The method of claim 54 wherein the catalytic composition includes a promoter comprising an alkaline earth metal compound.

69. The method of claim 68 wherein the alkaline earth metal compound is selected from the group consisting of oxides of magnesium, barium, calcium, strontium and mixtures thereof.

70. The method of claim 69 wherein the alkaline earth metal compound is present in an amount of about 0.02 to about 0.5 g/in³ of the carrier.

71. The method of claim 54 wherein the gas comprises an exhaust gas which emanates from a passenger vehicle or truck gasoline engine manifold, the catalyst member is present in a close-coupled or medium-coupled mode and the platinum-group metal catalytic component comprises a palladium metal catalytic component.

72. The method of claim 71 wherein the catalyst member is present in a close-coupled mode and the palladium metal catalytic component is present in an amount of about 20 to about 300 g/ft³ of the carrier.

73. The method of claim 72 wherein the palladium metal catalytic component is present in an amount of 50 to 200 g/ft³ of the carrier.

74. The method of claim 71 wherein the catalyst member comprises one or more upstream containers present in a close-coupled and/or medium-coupled mode and the catalyst composition is present in said containers in the form of a single brick, multiple bricks or pellets.

75. The method of claim 74 wherein the catalyst member further comprises one or more downstream containers located downstream of the upstream containers, said downstream containers containing a catalytic material effective at least for the oxidation of hydrocarbons and comprising one or more catalytic metal components disposed on a refractory metal oxide support and further comprising an oxygen storage component.

76. The method of claim 75 wherein the catalytic material is present in the downstream containers in the form of a single brick, multiple bricks or pellets.

77. The method of claim 75 wherein the catalytic metal component comprises rhodium.

78. The method of claim 75 wherein the catalytic metal component comprises palladium.

79. The method of claim 75 wherein the oxygen storage component comprises ceria.

80. The method of claim 77 further comprising an underfloor catalyst member comprising a catalytic material effective at least for the oxidation of hydrocarbons and comprising one or more catalytic metal components disposed on a refractory metal oxide support and further comprising an oxygen storage component.

81. The method of claim 80 wherein the catalytic metal component comprises rhodium.

82. The method of claim 80 wherein the catalytic metal component comprises palladium.

83. The method of claim 80 wherein the oxygen storage component comprises ceria.
